(19) United States
(12) Patent Application Publication
(10) Pub. No.: US 2015/0316150 A1
(43) Pub. Date: Nov. 5, 2015

(54) FISHBONE-LIKE HELICAL TOOTHED METALLIC GASKET

(71) Applicant: (ENVIRONMENTAL GASKET COMPANY, LTD.), Nanjing, Jiangsu (CN)

(72) Inventors: JINGWEI ZHAO, JIANGSU (CN); JUN ZHANG, JIANGSU (CN); FAN YANG, JIANGSU (CN)

(21) Appl. No.: 14/000,615

(22) PCT Filed: Feb. 7, 2013
(86) PCT No.: PCT/CN2013/071491

§ 371 Date: Aug. 21, 2013

(30) Foreign Application Priority Data
Jan. 29, 2013 (CN) 20131002805.X

(51) Int. Cl. F16J 15/08

(52) U.S. Cl. CPC F16J 15/0806; F16J 15/0818; F16J 15/0887

(57) ABSTRACT

A fishbone-like helical concentric toothed metallic gasket, upper and lower end faces of which are provided thereon with annular toothed grooves in the peripheral direction, wherein teeth of the toothed grooves are integrated with the metallic gasket and obliquely disposed towards a pressure source, the teeth having a cross-sectional shape looking like a fishbone and an oblique angle of greater than 0° and less than 90°, and a contact surface between top of the teeth and a flange forms a non-sharp corner is disclosed. Due to the oblique orientation of the toothed grooves on the surfaces of the rings, a plurality of enclosed pressure-resistant chambers are formed, so that pressure from the pressure source can be relieved step by step; and the closed chambers may generate an effective sealing compensation force by using fluid pressure, thereby improving the reliability of sealing.

### FIELD OF TECHNOLOGY

The following relates to a metallic sealing gasket, in particular to a fishbone-like helical concentric toothed metallic gasket.

### BACKGROUND

As a kind of flexible metallic gaskets, toothed gaskets (or so sometimes called “Kammprofile Gaskets) have stronger sealing body compared to flat metallic gaskets and spiral-wound gaskets, because they are machined from a single piece of metal. Generally, concentric dentate grooves with a waveform vertical to the flange face are machined on two surfaces of a flat stainless steel gasket by a precise lathe. Depending on different use parts and requirements, a toothed gasket may be machined into a combined gasket that is provided with internal and external positioning rings and additionally pasted with flexible graphite or polytetrafluoroethylene sheets on two surfaces thereof.

The toothed gaskets are advantageous for application to high-pressure and high-temperature portions, with high corrosion resistance and stable and reliable sealing performance. However, they also have some disadvantages: (1) the included vertical angle makes the fluid and fluid pressure easy to pass; (2) the toothed sharp contact corner against the sealing surface is likely to damage the flange face; and (3) metal itself has small resilience force and hardly generates a sealing compensation force by using fluid pressure.

### SUMMARY

In view of the disadvantages of the conventional toothed gaskets, the following provides a gasket with high resilience and pressure bearing capacity.

A first aspect relates to a fishbone-like helical concentric toothed metallic gasket is provided, upper and lower end faces of which are provided thereon with annular toothed grooves in the peripheral direction. Teeth of the toothed grooves are integrated with the metallic gasket and obliquely disposed towards a pressure source.

In a further aspect, the oblique angle of the teeth is greater than 0° and less than 90° with respect to the fluid direction. When the pressure source is located on the inner side of the gasket, the toothed rings are oblique inward; and when the pressure source is located on the outer side of the gasket, the toothed rings are oblique outward.

In a further aspect, a contact surface between the top of the teeth and a flange forms a non-sharp corner which may be designed to be a rounded contact corner, a flat contact corner or an arc contact corner or combination thereof

Another aspect provides that the annular toothed grooves have teeth of a single shape or teeth of combinations of multiple shapes. The toothed rings may be single circular toothed rings, single flat toothed rings or single arc toothed rings, and also may be combinations of such three toothed rings. The toothed rings may be disposed uniformly or non-uniformly.

In yet another aspect, the upper and lower end faces of the gasket may be pasted with graphite, polytetrafluoroethylene, asbestos, ceramic or other nonmetallic gaskets, integrally forming a combined gasket.

The present disclosure has the following advantages. (1) Due to the oblique arrangement of the toothed grooves of the gasket on the surfaces of the rings, a plurality of enclosed pressure-resistant chambers constricted towards the pressure source are formed, so that pressure from the pressure source may be relieved step by step. Such pressure relief chambers, through which the fluid or fluid pressure is hard to pass, can improve the reliability of sealing. (2) The top corner of the teeth is designed to be a rounded contact corner, so no damage is caused to the flange while the teeth come into contact with the surface of the flange, as a result, the flange may be reused. (3) The oblique metallic toothed rings have high resilience while stressed, and the enclosed chambers may generate an effective sealing compensation force by using fluid pressure, thereby improving the reliability of sealing.

### BRIEF DESCRIPTION

Some of the embodiments will be described in detail, with reference to the following figures, wherein like designations denote like members, wherein:

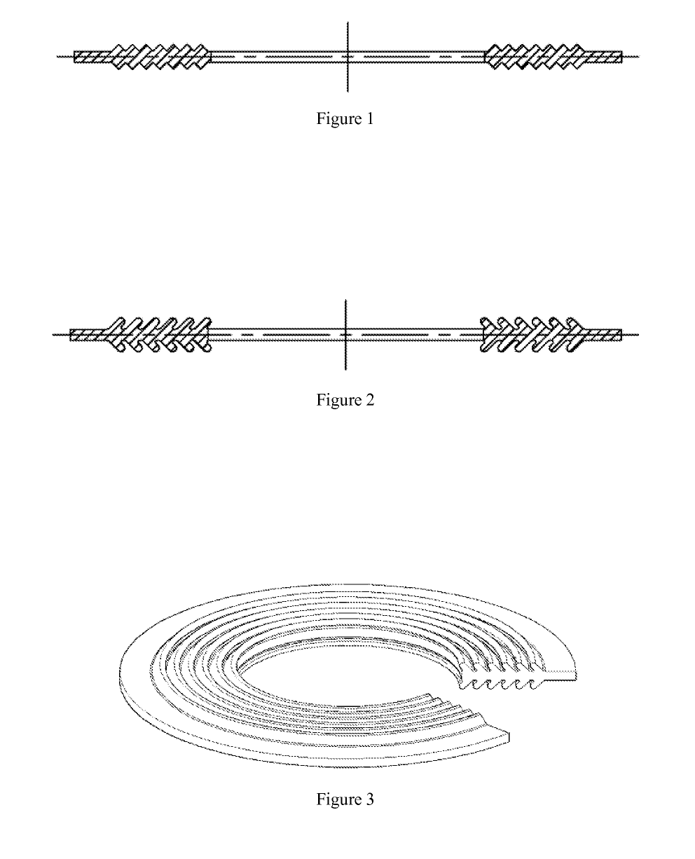

FIG. 1 is a structural diagram of an existing toothed gasket;

FIG. 2 is a structural diagram of a circular toothed gasket;

FIG. 3 is a stereogram of a circular toothed gasket;

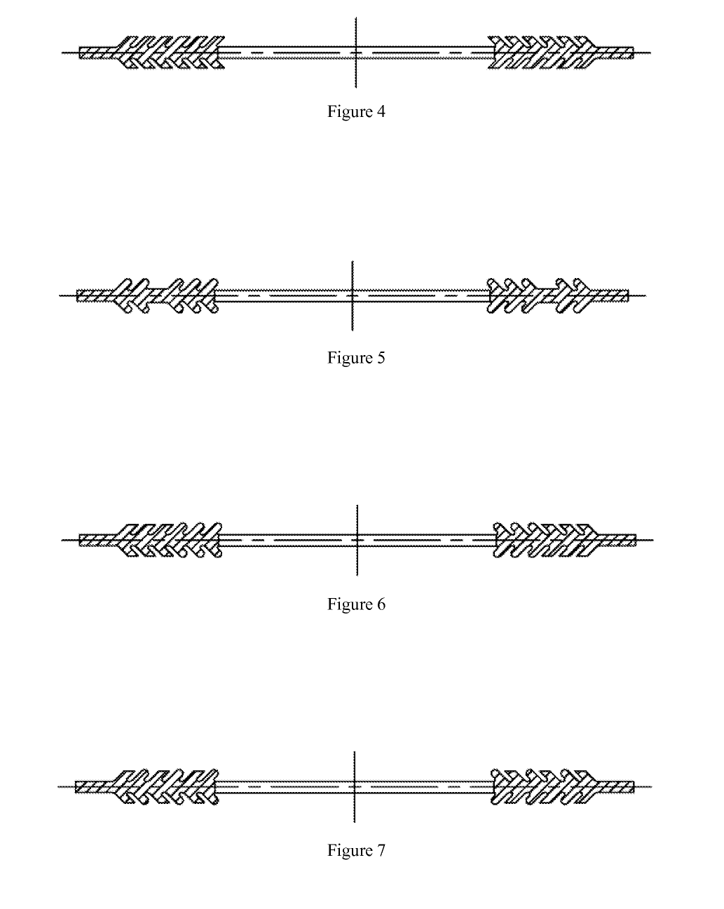

FIG. 4 is a structural diagram of a flat toothed gasket;

FIG. 5 is a schematic diagram of circular toothed rings when disposed non-uniformly;

FIG. 6 is a first schematic diagram of an embodiment of a gasket combing circular toothed rings and flat toothed rings; and

FIG. 7 is a second schematic diagram of an embodiment of a gasket combing circular toothed rings and flat toothed rings.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

Different from the existing sharp-corner gaskets of FIG. 1, the top corner of the teeth of the gasket provided in this invention is a non-sharp corner, and a part of or all the teeth are obliquely disposed towards a pressure source. When the pressure source is located on the inner side of the gasket, the toothed rings are oblique inward, referring to FIG. 2, FIG. 3 and FIG. 4. The teeth each have a top as a rounded contact corner or flat contact corner and all disposed uniformly. The cross-section of the whole gasket looks like a fishbone. FIG. 5 shows the non-uniform arrangement of circular toothed rings. Regions without teeth may be provided between the toothed rings, to form a dual-seal or multi-seal gasket structure.

In addition to the above single circular toothed or flat toothed structure, the gasket may also employ a combination of those two structures, referring to FIG. 6 and FIG. 7. The circular toothed rings and the flat toothed rings are disposed in a staggered form or combined in any way, to improve the resilience of the gasket.

In the invention, after the top corner of the teeth is designed to be a rounded contact corner, a flat contact corner or an arc contact corner, the part contacted with the flange face forms an arc or a plane, damage to the flange face by traditional sharp corners is thus avoided. The oblique arrangement of the toothed grooves on the surfaces of the rings makes pressure from the pressure source relieved step by step, thereby improving the reliability of sealing. The shape of other parts, except the top corner, of the teeth is not limited, and may have various changes.

In addition, the upper and lower end faces of the gasket may be combined with nonmetallic gaskets, such as graphite gaskets. When a metallic toothed gasket is used, graphite on the upper and lower surfaces of the metallic rings is contacted with a sealing element, thus enhancing the sealing effect and reducing the wear rate. Meanwhile, when the metallic gasket is cleaned, replaced or overlapped, the metallic toothed gasket may be used again as long as graphite on the metallic toothed gasket is renewed, thereby improving the use efficiency and reducing the industrial use cost.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

1. A fishbone-like helical concentric toothed metallic gasket comprising:
an upper end face and a lower end face provided on the fishbone-like helical concentric toothed metallic gasket; and
a plurality of annular toothed grooves in a peripheral direction, wherein the teeth of the plurality of annular toothed grooves have an angle greater than 0° and less than 90° with respect to a fluid direction, and are integrated with the fishbone-like helical concentric toothed metallic gasket with and obliquely disposed towards a pressure source.

2. The fishbone-like helical concentric toothed metallic gasket according to claim 1, wherein characterized in that a contact surface between a top of the teeth of the plurality of annular toothed grooves and a flange forms a non-sharp contact corner.

3. The fishbone-like helical concentric toothed metallic gasket according to claim 2, wherein the top of the teeth of the plurality of annular toothed grooves is designed to be a rounded contact corner, a flat contact corner, an arc contact corner, or combinations thereof.

4. The fishbone-like helical concentric toothed metallic gasket according to claim 2, wherein the teeth of the plurality of annular toothed grooves have teeth of a single shape or teeth of combinations of multiple shapes.

5. The fishbone-like helical concentric toothed metallic gasket according to claim 1, wherein a space for arrangement of the plurality of annular toothed grooves in the peripheral direction of the gasket is uniform or non-uniform.
